(19) United States
(12) Patent Application Publication
(10) Pub. No.: US 2015/0314380 A1
(43) Pub. Date: Nov. 5, 2015

(54) CUTTING METHOD AND CUTTING APPARATUS

(71) Applicant: TOYOTA JIDOSHA KABUSHIKI KAISHA, Toyota-shi, Aichi (JP)

(72) Inventor: Kazumi SAITO, Okazaki-shi, Aichi (JP)

(73) Assignee: TOYOTA JIDOSHA KABUSHIKI KAISHA, Toyota-shi, Aichi (JP)

(21) Appl. No.: 14/654,020

(22) PCT Filed: Dec. 20, 2012
(86) PCT No.: PCT/JP2012/083145

§ 371 Date: Jun. 19, 2015

(51) Int. Cl. B23D 27/00; B26D 5/02

(52) U.S. Cl. CPC B23D 27/00; B26D 5/02

(57) ABSTRACT

Provided is a technique capable of accurately cutting steel sheets of various shapes into desired shapes. A cutting method is a method for cutting a steel sheet by using a nibbler having a cylindrical case, a punch housed inside the case, and a die provided below the case, the nibbler making the punch continuously punch the steel sheet while moving. The cutting method includes: providing a guide member in the vicinity of the die of the nibbler located at a cutting position along a moving path of the nibbler, the guide member having a first guide surface for restricting movement of the nibbler from the cutting position to a first side of a direction perpendicular to a traveling direction and a top-bottom direction of the nibbler by contact with a side surface of the die; and moving the nibbler along the guide member.

### TECHNICAL FIELD

The present invention relates to a cutting apparatus and a cutting method for cutting a steel sheet.

### BACKGROUND ART

Conventionally, a nibbler is widely known as a device for cutting a steel sheet.

Generally, the nibbler includes a cylindrical case, a punch arranged in the case, and a die arranged below the case. The nibbler makes the punch continuously punch a steel sheet fed between the case and the die while moving, thereby cutting the steel sheet.

JP 9-234622 A discloses a nibbler configured to be grasped and moved by an operator to cut a steel sheet.

The nibbler described in JP 9-234622 A can move linearly by sliding a linear guide plate of a cutting jig mounted on the nibbler on the side edge of the rectangular steel sheet.

Furthermore, the nibbler described in JP 9-234622 A can move circularly around a hole formed in a steel sheet by inserting a center part of the cutting jig mounted on the nibbler into the hole.

However, it is disadvantageous in that the nibbler described in JP 9-234622 A can linearly cut only a steel sheet having a linear side edge (e.g., a rectangular steel sheet) because the nibbler cut the steel sheet linearly by utilizing the linear guide plate of the cutting jig, which slides on the side edge of the steel sheet.

Moreover, the nibbler described in JP 9-234622 A can cut the steel sheet circularly by utilizing the center part of the cutting jig, which is inserted into the hole formed in the steel sheet, but has a disadvantage of not cutting the steel sheet in a complicated curve.

### CITATION LIST

### Patent Literature

PTL1: JP 9-234622 A

### SUMMARY OF INVENTION

### Technical Problem

The object of the present invention is to provide a technique capable of accurately cutting steel sheets of various shapes into desired shapes.

### Solution to Problem

A first aspect of the invention is a cutting method for cutting a steel sheet by using a nibbler having a cylindrical case, a punch housed inside the case, which reciprocates in a top-bottom direction, and a die provided below the case, the nibbler making the punch continuously punch the steel sheet fed between the case and the die while moving, the cutting method including: providing a guide member in the vicinity of the die of the nibbler located at a cutting position along a moving path of the nibbler, the guide member having a first guide surface for restricting movement of the nibbler from the cutting position to a first side of a direction perpendicular to a traveling direction of the nibbler and the top-bottom direction by contact with a side surface of the die of the nibbler located at the cutting position; and moving the nibbler along the guide member.

Preferably, the guide member further has a second guide surface for restricting downward movement of the nibbler from the cutting position by contact with a lower surface of the die of the nibbler located at the cutting position.

Preferably, the guide member further has a third guide surface arranged on a side opposite to the first guide surface with respect to the die, for restricting movement of the nibbler from the cutting position to a second side of the direction perpendicular to the traveling direction of the nibbler and the top-bottom direction by contact with a side surface of the die of the nibbler located at the cutting position.

Preferably, the guide member comes in contact with a lower surface of a removed part that is an unnecessary part of the steel sheet to support the removed part from below.

Preferably, a part of the guide member, which is come in contact with the removed part of the steel sheet is made of a buffer material.

Preferably, the above-mentioned method further includes: mounting the nibbler on a robot having an arm capable of changing a position and a posture of the arm; and controlling the robot to move the nibbler along the guide member.

A second aspect of the invention is a cutting apparatus for cutting a steel sheet, including: at least one robot having an arm capable of changing a position and a posture of the arm; a nibbler that has a cylindrical case, a punch housed inside the case, which reciprocates in a top-bottom direction to punch the steel sheet, and a die provided below the case, and that is mounted on a tip of the arm of the robot; a guide member provided in the vicinity the die of the nibbler located at a cutting position along a moving path of the nibbler; and a controller that controls the robot to move the nibbler along the guide member. The guide member has a first guide surface for restricting movement of the nibbler from the cutting position to a first side of a direction perpendicular to a traveling direction of the nibbler and the top-bottom direction by contact with a side surface of the die of the nibbler located at the cutting position.

Preferably, the guide member further has a second guide surface for restricting downward movement of the nibbler from the cutting position by contact with a lower surface of the die of the nibbler located at the cutting position.

Preferably, the guide member further has a third guide surface arranged on a side opposite to the first guide surface with respect to the die, for restricting movement of the nibbler from the cutting position to a second side of the direction perpendicular to the traveling direction of the nibbler and the top-bottom direction by contact with a side surface of the die of the nibbler located at the cutting position.

Preferably, the guide member comes in contact with a lower surface of a removed part that is an unnecessary part of the steel sheet to support the removed part from below.

Preferably, a part of the guide member, which is come in contact with the removed part of the steel sheet is made of a buffer material.

### Advantageous Effects of Invention

The present invention makes it possible to accurately cut steel sheets of various shapes into desired shapes.

### BRIEF DESCRIPTION OF DRAWINGS

FIG. 1 shows a cutting apparatus according to an embodiment of the present invention.

FIG. 2 shows a nibbler provided in the cutting apparatus according to the embodiment of the present invention, in which FIG. 2A is a sectional side view, and FIG. 2B is a sectional view taken along line A-A in FIG. 2A.

FIG. 3 is a plan view of a steel sheet, showing a moving path of the nibbler.

FIG. 4 shows a guide member.

FIG. 5 shows the guide member.

FIG. 6 shows another embodiment of the guide member and another embodiment of the nibbler.

FIG. 7 shows another embodiment of the guide member.

FIG. 8 shows another embodiment of the guide member and another embodiment of the nibbler.

FIG. 9 shows another embodiment of the guide member.

FIG. 10 shows another embodiment of the guide member.

### DESCRIPTION OF EMBODIMENTS

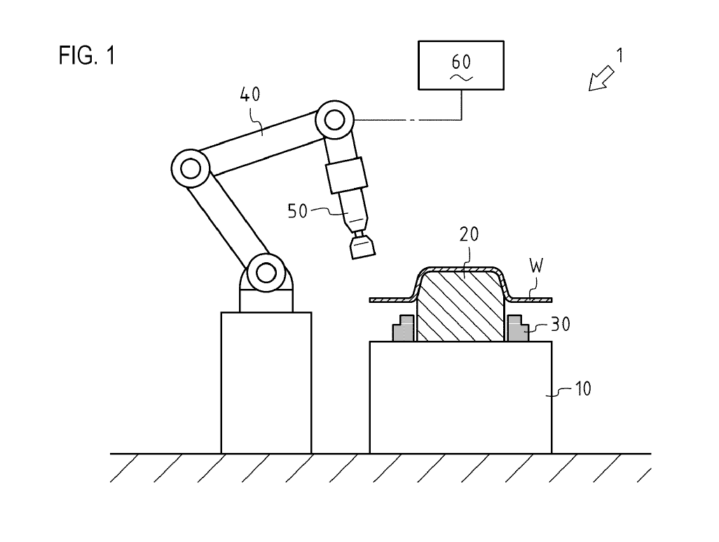

With reference to FIGS. 1 to 3, a cutting apparatus 1 as an embodiment of a cutting apparatus according to the present invention is described below.

The cutting apparatus 1 cuts a workpiece W.

The workpiece W is a steel sheet having a central part protruding upward, and a flange horizontally extending, which is formed around the central part.

As shown in FIG. 1, the cutting apparatus 1 includes a support stand 10, a lower die 20, a guide member 30, a robot 40, a nibbler 50, and a controller 60.

The support stand 10 is a stand that supports the lower die 20 and the guide member 30. On the support stand 10, the lower die 20 and the guide member 30 are fixed.

The lower die 20 is a member on which the workpiece W is placed. The lower die 20 is configured to fix the workpiece W. The lower die 20 supports only the central part of the workpiece W such that the flange of the workpiece W is located outside the lower die 20.

The guide member 30 is a member that guides the nibbler 50 such that the nibbler 50 does not deviate from a predetermined moving path. The guide member 30 is provided along the moving path of the nibbler 50 so as to surround the lower die 20, and arranged below the flange of the workpiece W.

A detailed structure of the guide member 30 will be described later.

The robot 40 has an arm with multiple joints. The robot 40 is configured to change a position and a posture of the arm. The nibbler 50 is mounted on the tip of the arm of the robot 40.

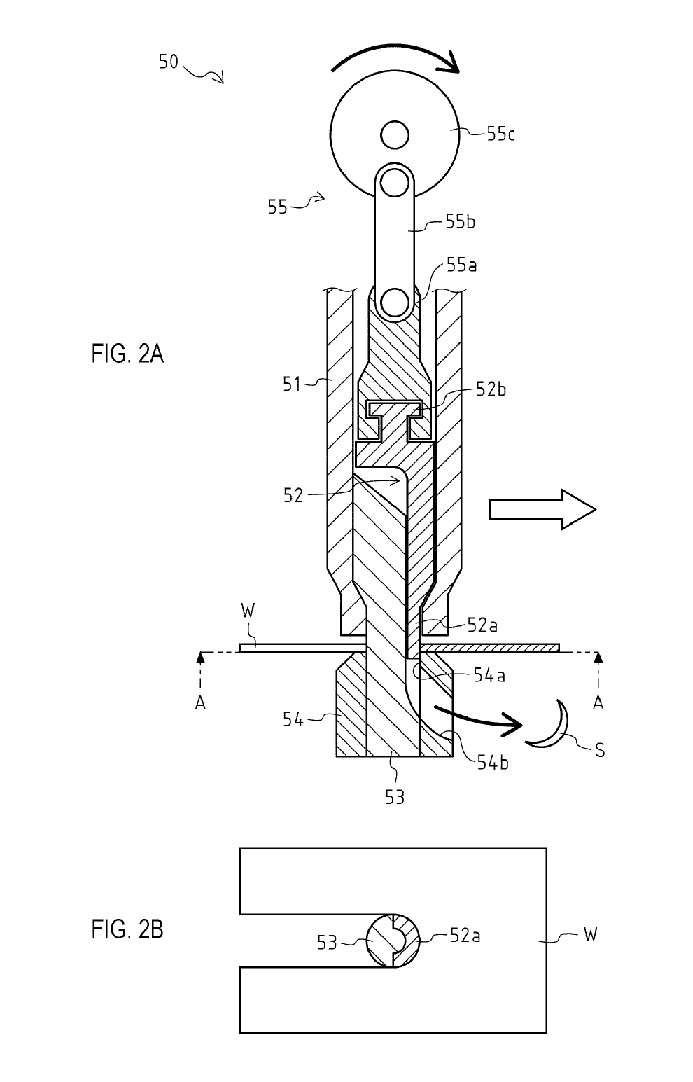

As shown in FIGS. 2A and 2B, the nibbler 50 is a device that continuously punches the workpiece W while moving. The nibbler 50 includes a case 51, a punch 52, a supporting part 53, a die body 54, and a driving part 55.

For convenience, the top-bottom direction in FIG. 2A is defined as a top-bottom direction of the nibbler 50.

The case 51 is formed in substantially a cylinder extending in the top-bottom direction, and has an opened lower end part.

The punch 52 is housed in the case 51 so as to slide in the top-bottom direction.

The supporting part 53 for supporting the case 51 and the die body 54 is fixed to the inner circumferential surface of the case 51.

The punch 52 reciprocates in the top-bottom direction at a predetermined frequency to punch the workpiece W. The punch 52 has a blade 52a and a connecting part 52b.

The blade 52a has a sectional shape of substantially a horseshoe, and the lower end thereof is formed as a blade edge for punching the workpiece W. The blade 52a protrudes downward from the lower end of the case 51 to enter an after-mentioned die hole 54a when the punch 52 arrives at the bottom dead center.

The connecting part 52b is connected to the driving part 55 such that the driving part 55 reciprocates the punch 52 in the top-bottom direction.

The supporting part 53 is a member that supports the case 51 and the die body 54. The upper end part of the supporting part 53 is fixed to the inner circumferential surface of the case 51, and the supporting part 53 extends downward from the inside of the case 51. The supporting part 53 has such a shape that an opening coincident with the sectional shape of the blade 52a is formed on the lower end surface of the case 51. In other words, a space in which the punch 52 is housed is formed between the case 51 and a part of the supporting part 53 inserted into the case 51, and the opening formed on the lower end surface of the case 51 has the shape coincident with the sectional shape of the blade 52a.

The die body 54 is fixed to the lower end part of the supporting part 53.

The die body 54 is arranged below the case 51 so as to be on the opposite side of the case 51 across the workpiece W. The die body 54 is formed in substantially a cylinder. The die body 54 is fixed to the supporting part 53 so as to cover the lower end part of the supporting part 53. The die body 54 has the die hole 54a and an ejecting hole 54b.

The die hole 54a is formed such that the blade 52a enters thereinto when the punch 52 arrives at the bottom dead center. Specifically, the die hole 54a is formed between the die body 54 and a part of the supporting part 53 inserted into the die body 54. The die hole 54a has a shape coincident with the sectional shape of the blade 52a, and opens on the upper end surface of the die body 54.

The ejecting hole 54b is a hole through which a crescentic scrap S punched from the workpiece W by the punch 52 is ejected to the outside of the die body 54. The ejecting hole 54b is formed on the side surface of the die body 54, and communicates with the die hole 54a.

The die body 54, and the part of the supporting part 53 inserted into the die body 54 correspond to a “die” according to the present invention.

The driving part 55 reciprocates the punch 52 in the top-bottom direction at a predetermined frequency. The driving part 55 has a connecting part 55a, a rod 55b, and a motor 55c.

The connecting part 55a is connected to the connecting part 52b of the punch 52.

The rod 55b is connected to the motor 55c and the connecting part 55a so as to transmit power of the motor 55c to the connecting part 55a.

The motor 55c transmits the power to the connecting part 55a through the rod 55b. Revolution of the motor 55c is converted into vertical movement of the connecting part 55a through the rod 55b.

As mentioned above, the nibbler 50 makes the punch 52 reciprocate in the top-bottom direction (direction in which punch 52 moves into and out of proximity with the die body 54) while being moved by the robot 40 with the workpiece W interposed between the case 51 and the die body 54, thereby continuously punching the workpiece W.

As shown in FIG. 1, the controller 60 is electrically connected to the robot 40 and controls the robot 40. The controller 60 controls the robot 40 such that the nibbler 50 mounted on the tip of the arm of the robot 40 moves along a preset path.

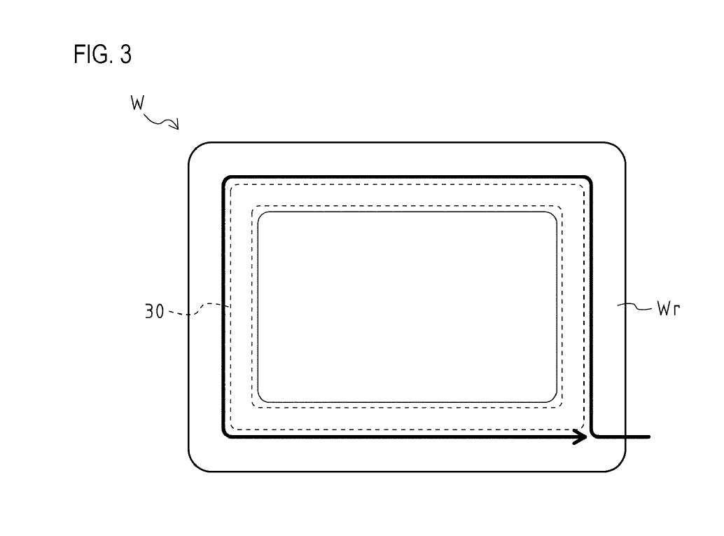

As shown in FIG. 3, in the present embodiment, the controller 60 controls the robot 40 such that the nibbler 50 moves over the whole circumference of the flange of the workpiece W to remove a removed part Wr that is an unnecessary part of the flange of the workpiece W.

FIG. 3 is a plan view of the workpiece W, and the arrow on the workpiece W shows a moving path of the nibbler 50. In the present embodiment, the workpiece W is formed in substantially rectangle in plan view.

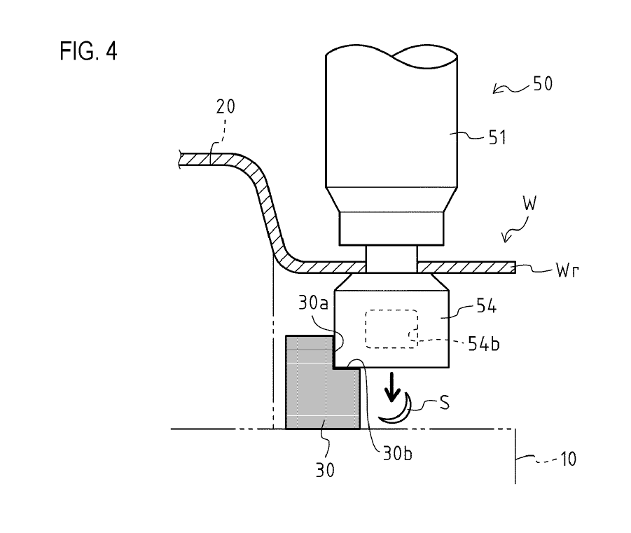

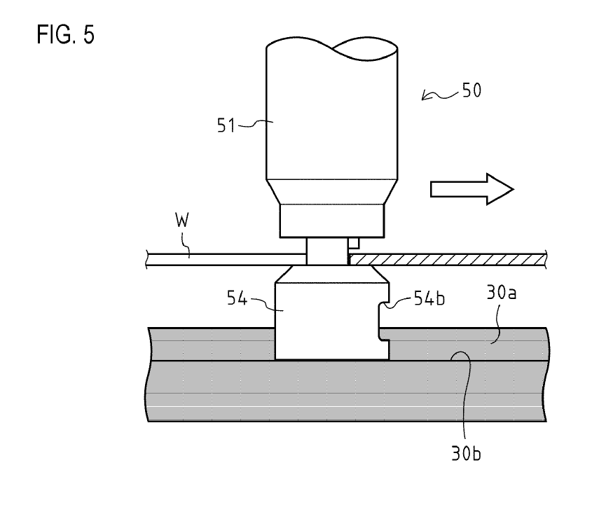

With reference to FIGS. 4 to 5, a structure of the guide member 30 is hereinafter described in detail.

As shown in FIG. 4, the guide member 30 is arranged in the vicinity of the die body 54 of the nibbler 50 located at a position in cutting of the workpiece W (hereinafter referred to as a “cutting position”) on a side closer to the lower die 20 than the nibbler 50, namely on a side opposite to the removed part Wr of the workpiece W. The guide member 30 is continuously formed along the moving path of the nibbler 50 so as to surround the lower die 20 (see FIG. 3).

As shown in FIGS. 4 and 5, the guide member 30 has a first guide surface 30a and a second guide surface 30b.

The first guide surface 30a is formed in the vertical direction so as to be in contact with a side surface, on a side close to the lower die 20, of the die body 54 of the nibbler 50 located at the cutting position. The first guide surface 30a is continuously formed along the moving path of the nibbler 50 so as to be always in contact with the side surface of the die body 54 when the nibbler 50 cuts the workpiece W.

The thus formed first guide surface 30a restricts movement of the die body 54 to a side closer to the lower die 20 than the first guide surface 30a when the nibbler 50 cuts the workpiece W.

Consequently, the controller 60 controls the robot 40 to slide the die body 54 on the first guide surface 30a, so that it is possible to suppress deviation of the nibbler 50 from the moving path.

Accordingly, the workpiece W can be accurately cut in a desired shape regardless of the shape of the workpiece W.

The second guide surface 30b is horizontally formed so as to be in contact with the lower surface of the die body 54 of the nibbler 50 located at the cutting position. The second guide surface 30b is continuous to the first guide surface 30a, and extends from the lower end of the first guide surface 30a toward a side close to the removed part Wr of the workpiece W. The second guide surface 30b is formed so as to be in contact with a part, on a side close to the lower die 20, of the lower surface of the die body 54 of the nibbler 50 located at the cutting position. The second guide surface 30b is continuously formed along the moving path of the nibbler 50 so as to be always in contact with the lower surface of the die body 54 when the nibbler 50 cuts the workpiece W.

The thus formed second guide surface 30b restricts downward movement of the die body 54 with respect to the second guide surface 30b when the nibbler 50 cuts the workpiece W.

Consequently, the controller 60 controls the robot 40 to slide the die body 54 on the second guide surface 30b, so that it is possible to hold a position, in the vertical direction to the workpiece W, of the nibbler 50, and to properly cut the workpiece W.

Particularly, even in a case where the flange of the workpiece W has a shape curved such that the vertical position is displaced, it is possible to hold the position, in the vertical direction to the workpiece W, of the nibbler 50, and to properly cut the workpiece W.

The second guide surface 30b is formed so as not to be located below the ejecting hole 54b formed in the die body 54 of the nibbler 50 located at the cutting position. In other words, the second guide surface 30b is formed so as to be located between the first guide surface 30a and the ejecting hole 54b.

Consequently, the scrap S punched from the workpiece W can be prevented from being ejected on the second guide surface 30b and hindering movement of the nibbler 50.

The thus configured guide member 30 guides the nibbler 50 such that the nibbler 50 does not deviate from the moving path, when the nibbler 50 cuts the workpiece W. In other words, the nibbler 50 is moved so as to slide the die body 54 on the first guide surface 30a and the second guide surface 30b of the guide member 30, so that the workpiece W can be accurately cut without deviation of the nibbler 50 from the moving path.

The guide member 30 is formed with the first guide surface 30a and the second guide surface 30b in the present embodiment, but may be formed with at least the first guide surface 30a.

Additionally, there can be provided a guide member formed with only a first guide surface, and a guide member formed with only a second guide surface.

In the present embodiment, the guide member 30 is provided on the side closer to the lower die 20 than the nibbler 50 located at the cutting position, and the first guide surface 30a restricts the movement of the nibbler 50 from the cutting position to the side close to the lower die 20. However, a guide member configured in a substantially similar manner to the guide member 30 may be provided on a side closer to the removed part Wr of the workpiece W than the nibbler 50 in place of the guide member 30, and a first guide surface of this guide member may restrict movement of the nibbler 50 from the cutting position to the side close to the removed part Wr of the workpiece W. In other words, the first guide surface of the guide member may restrict movement of the nibbler 50 from the cutting position to one side of a direction perpendicular to the advancing direction of the nibbler 50 along a horizontal plane (strictly, a surface of a part, punched by the punch 52 of the nibbler 50, of the flange of the workpiece W).

However, the guide member is provided on the side closer to the lower die 20 than the nibbler 50 located at the cutting position, so that the guide member is not located below the removed part Wr of the workpiece W, and the removed part Wr is ejected without staying on the guide member when being removed from the workpiece W completely. Therefore, the guide member is preferably provided on the side closer to the lower die 20 than the nibbler 50 located at the cutting position.

In the present embodiment, the die body 54 of the nibbler 50 abuts on the first guide surface 30a and the second guide surface 30b formed in the guide member 30, so that the movement of the nibbler 50 from the cutting position to the side close to the lower die 20, and the downward movement of the nibbler 50 from the cutting position are restricted. However, the present invention is not limited to this configuration.

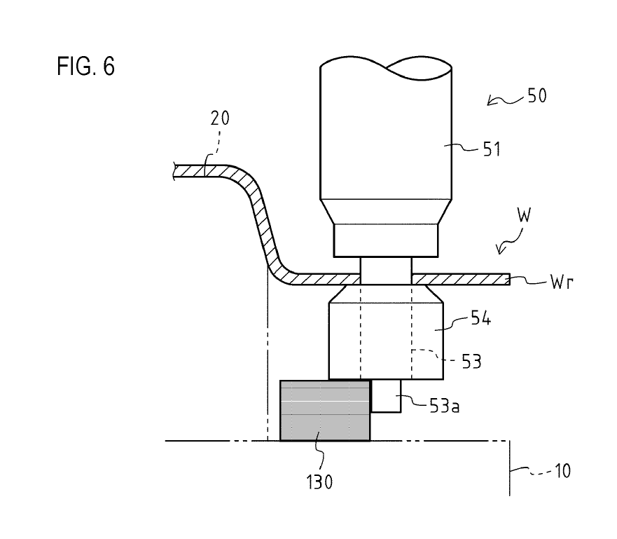

For example, as shown in FIG. 6, a protrusion 53a is provided as a part of the die on the lower end surface of the supporting part 53 of the nibbler 50, and a guide member 130 is provided in place of the guide member 30, so that the movement of the nibbler 50 from the cutting position to the side close to the lower die 20, and the downward movement of the nibbler 50 from the cutting position may be restricted.

The protrusion 53a is formed in a columnar shape having a smaller outer diameter than the die body 54, and protrudes downward from the lower end surface of the supporting part 53.

The guide member 130 is arranged below the flange of the workpiece W on a side closer to the lower die 20 than the nibbler 50 located at the cutting position. The guide member 130 has a rectangular sectional shape, and is continuously formed along the moving path of the nibbler 50 so as to surround the lower die 20. The guide member 130 is formed such that a side surface, on a side close to the removed part Wr, of the workpiece W is in contact with the side surface of the die body 54 of the nibbler 50 located at the cutting position, and an upper surface is in contact with the lower surface of the die body 54 of the nibbler 50 located at the cutting position.

With such a configuration, the controller 60 controls the robot 40 to slide the protrusion 53a on the side surface of the guide member 130, and to slide the die body 54 on the upper surface of the guide member 130, so that the workpiece W can be accurately cut without deviation of the nibbler 50 from the moving path. In other words, the side surface, on the side close to the removed part Wr of the workpiece W, of the guide member 130 functions as the first guide surface according to the present invention, and the upper surface of the guide member 130 functions as the second guide surface according to the present invention.

In the present embodiment, the guide member 30 is provided on the side closer to the lower die 20 than the nibbler 50 located at the cutting position, and the first guide surface 30a restricts the movement of the nibbler 50 from the cutting position to the side close to the lower die 20. However, it is also possible to restrict both the movement of the nibbler 50 from the cutting position to the side close to the lower die 20, and the movement of the nibbler 50 from the cutting position to the side close to the removed part Wr of the workpiece W.

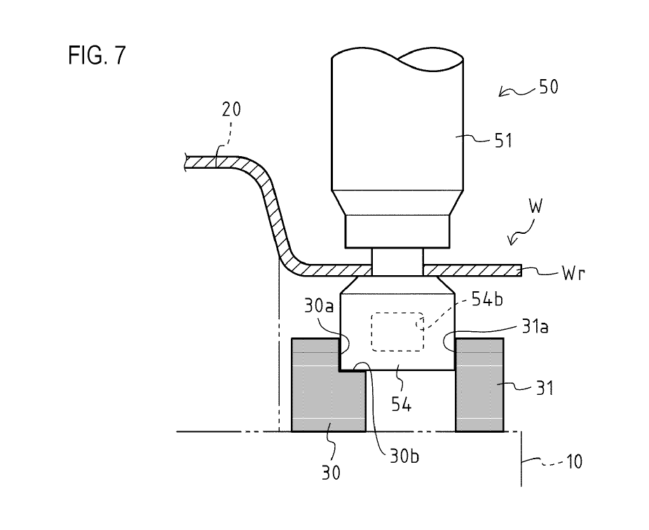

For example, as shown in FIG. 7, a guide member 31 may be further provided in addition to the guide member 30.

The guide member 31 is arranged below the flange of the workpiece W on a side closer to the removed part Wr of the workpiece W than the nibbler 50 located at the cutting position. In other words, the guide member 31 is arranged below the removed part Wr of the workpiece W. The guide member 31 has a rectangular sectional shape, and is continuously formed along the moving path of the nibbler 50. On a side surface, on a side close to the lower die 20, of the guide member 31, a third guide surface 31a that is in contact with the side surface of the die body 54 of the nibbler 50 located at the cutting position is formed.

With such a configuration, the controller 60 controls the robot 40 to slide the die body 54 on the first guide surface 30a of the guide member 30 and on the third guide surface 31a of the guide member 31, so that it is possible to suppress deviation of the nibbler 50 from the moving path.

Particularly, the guide member 31 is provided such that the die body 54 is sandwiched between the guide member 31 and the guide member 30, and therefore the workpiece W can be cut with extremely high accuracy. In other words, the first guide surface 30a of the guide member 30 functions as a first guide surface according to the present invention, which restricts the movement of the nibbler 50 from the cutting position to the side close to the lower die 20, and the third guide surface 31a of the guide member 31 functions as a third guide surface according to the present invention, which restricts the movement of the nibbler 50 from the cutting position to the side close to the removed part Wr of the workpiece W.

A surface similar to the second guide surface 30b of the guide member 30 can be formed in the guide member 31.

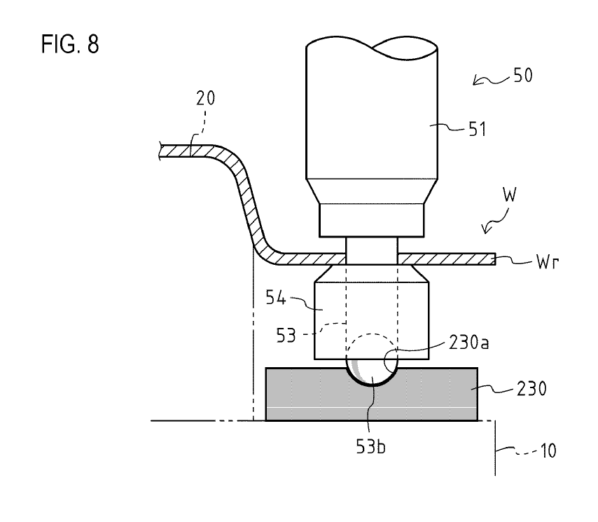

As shown in FIG. 8, a sphere 53b is provided as a part of the die on the lower end of the supporting part 53 of the nibbler 50, and a guide member 230 is provided in place of the guide member 30, so that the movement of the nibbler 50 from the cutting position to the side close to the lower die 20, the movement of the nibbler 50 from the cutting position to the side close to the removed part Wr of the workpiece W, and the downward movement of the nibbler 50 from the cutting position may be restricted.

The sphere 53b is formed in a spherical shape having the substantially similar outer diameter to the outer diameter of the lower end surface of the supporting part 53. The sphere 53b has a lower part fixed to the supporting part 53 so as to protrude downward from the lower end surface of the supporting part 53.

The guide member 230 is arranged below the flange of the workpiece W so as to support the nibbler 50 located at the cutting position. The guide member 230 has a substantially rectangular sectional shape, and is continuously formed along the moving path of the nibbler 50 so as to surround the lower die 20. A groove 230a having a circular arc sectional shape allowing the sphere 53b to be fit is formed in the upper surface of the guide member 230 along the moving path of the nibbler 50 continuously. The guide member 230 is formed such that the surface of the groove 230a is in contact with the surface of the lower part of the sphere 53b in the nibbler 50 located at the cutting position.

With such a configuration, the controller 60 controls the robot 40 to slide the sphere 53b on the surface of the groove 230a of the guide member 230, so that the workpiece W can be cut with extremely high accuracy without deviation of the nibbler 50 from the moving path. In other words, the surface of the groove 230a of the guide member 230 functions as the first guide surface, the second guide surface, and the third guide surface according to the present invention. The sphere 53b can be rotatably mounted on the supporting part 53.

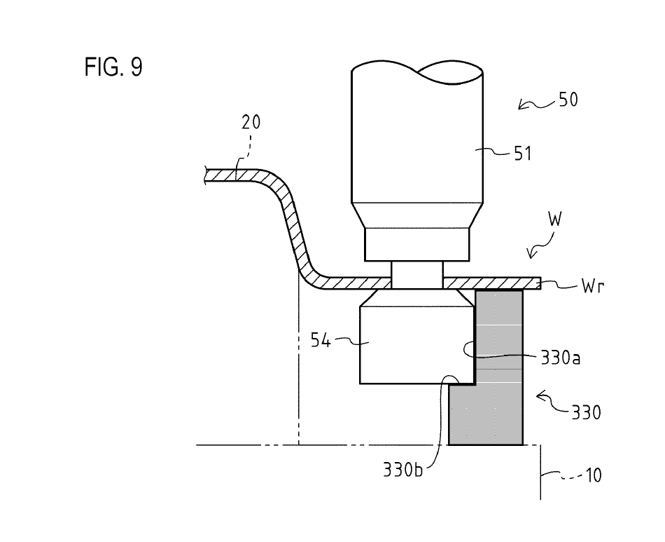

As shown in FIG. 9, a guide member 330 can be provided in place of the guide member 30.

The guide member 330 is arranged below the flange of the workpiece W on a side closer to the removed part Wr of the workpiece W than the nibbler 50 located at the cutting position. In other words, the guide member 330 is arranged below the removed part Wr of the workpiece W. The guide member 330 is configured such that an upper surface thereof is in contact with the lower surface of the removed part Wr of the workpiece W. In other words, the guide member 330 is configured so as to support the removed part Wr of the workpiece W from below. The guide member 330 is continuously formed along the moving path of the nibbler 50 so as to surround the lower die 20. The guide member 330 has a first guide surface 330a and a second guide surface 330b.

The first guide surface 330a is vertically formed so as to be in contact with a side surface, on a side close to the removed part Wr of the workpiece W, of the die body 54 of the nibbler 50 located at the cutting position. The first guide surface 330a is continuously formed along the moving path of the nibbler 50 so as to be always in contact with the side surface of the die body 54 when the nibbler 50 cuts the workpiece W.

The second guide surface 330b is horizontally formed so as to be in contact with the lower surface of the die body 54 of the nibbler 50 located at the cutting position. The second guide surface 330b is continuous to the first guide surface 330a, and extends from the lower end of the first guide surface 330a toward the side close to the lower die 20. The second guide surface 330b is formed so as to be in contact with a part, on the side close to the removed part Wr of the workpiece W, of the lower surface of the die body 54 of the nibbler 50 located at the cutting position. The second guide surface 330b is continuously formed along the moving path of the nibbler 50 so as to be always in contact with the lower surface of the die body 54 when the nibbler 50 cuts the workpiece W.

The thus configured guide member 330 guides the nibbler 50 such that the nibbler 50 does not deviate from the moving path when the nibbler 50 cuts the workpiece W. In other words, the controller 60 controls the robot 40 to slide the die body 54 on the first guide surface 330a and the second guide surface 330b of the guide member 330, so that it is possible to accurately cut the workpiece W without deviation of the nibbler 50 from the moving path.

Furthermore, the guide member 330 is configured so as to support the removed part Wr of the workpiece W, and therefore it is possible to reduce vertical vibration of the removed part Wr of the workpiece W when the nibbler 50 cuts the workpiece W.

Accordingly, it is possible to reduce noise generated when the removed part Wr of the workpiece W collides with the guide member 330.

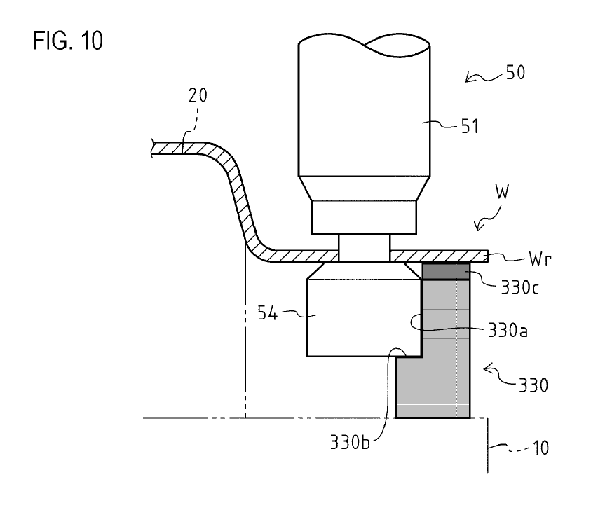

As shown in FIG. 10, a part, in contact with the removed part Wr of the workpiece W, of the guide member 330 is preferably a buffer part 330c.

The buffer part 330c is made of a buffer material, and the removed part Wr of the workpiece W can reduce impact generated when colliding with the buffer part 330c.

Accordingly, the buffer part 330c is provided in the guide member 330, so that it is possible to further reduce the noise generated when the removed part Wr of the workpiece W collides with the guide member 330.

A guide member different from the guide member 330 is provided on the side closer to the lower die 20 than the nibbler 50 located at the cutting position, and the die body 54 can be sandwiched between the above guide member and the guide member 330.

Consequently, the workpiece W can be cut with extremely high accuracy.

In the present embodiment, the nibbler 50 is moved such that a part of the die (the die body 54, the protrusion 53a, or the sphere 53b) of the nibbler 50 located at the cutting position slides on the guide member. However, the nibbler 50 can be moved so as to form a minute clearance between the die of the nibbler 50, and the guide member. In other words, positional relation between the nibbler 50 and the guide member can be maintained when the nibbler 50 cuts the workpiece W, and the nibbler 50 can abut on the guide member to restrict movement of the nibbler 50 in a predetermined direction in a case where the nibbler 50 moves so as to deviate from the moving path.

The number of the robots 40 in the cutting apparatus 1 is not limited, and at least one robot 40 mounted with the nibbler 50 may be provided.

In a case where two or more robots 40 are provided, at least one robot 40 should be mounted with the nibbler 50.

Additionally, an operator can hold the nibbler to cut a steel sheet along the guide member according to the present invention.

### INDUSTRIAL APPLICABILITY

The present invention is applicable to a cutting apparatus and a cutting method for cutting a steel sheet.

### REFERENCE SIGNS LIST

1: cutting apparatus

10: support stand

20: lower die

30: guide member

30a: first guide surface

30b: second guide surface

31: guide member

31a: third guide surface

40: robot

50: nibbler

54: die body

60: controller

W: workpiece (steel sheet)

Wr: removed part

1. A cutting method for cutting a steel sheet by using a nibbler having a cylindrical case, a punch housed inside the case, which reciprocates in a top-bottom direction, and a die provided below the case, the nibbler making the punch continuously punch the steel sheet fed between the case and the die while moving, the cutting method comprising:
providing a guide member in the vicinity of the die of the nibbler located at a cutting position along a moving path of the nibbler, the guide member having a first guide surface for restricting movement of the nibbler from the cutting position to a first side of a direction perpendicular to a traveling direction of the nibbler and the top-bottom direction by contact with a side surface of the die of the nibbler located at the cutting position; and
moving the nibbler along the guide member.

2. The cutting method according to claim 1, wherein
the guide member further has a second guide surface for restricting downward movement of the nibbler from the cutting position by contact with a lower surface of the die of the nibbler located at the cutting position.

3. The cutting method according to claim 1, wherein
the guide member further has a third guide surface arranged on a side opposite to the first guide surface with respect to the die, for restricting movement of the nibbler from the cutting position to a second side of the direction perpendicular to the traveling direction of the nibbler and the top-bottom direction by contact with a side surface of the die of the nibbler located at the cutting position.

4. The cutting method according to claim 1, wherein
the guide member comes in contact with a lower surface of a removed part that is an unnecessary part of the steel sheet to support the removed part from below.

5. The cutting method according to claim 4, wherein
a part of the guide member, which is come in contact with the removed part of the steel sheet is made of a buffer material.

6. The cutting method according to claim 1, further comprising:
mounting the nibbler on a robot having an arm capable of changing a position and a posture of the arm; and
controlling the robot to move the nibbler along the guide member.

7. A cutting apparatus for cutting a steel sheet, comprising:
at least one robot having an arm capable of changing a position and a posture of the arm;
a nibbler that has a cylindrical case, a punch housed inside the case, which reciprocates in a top-bottom direction to punch the steel sheet, and a die provided below the case, and that is mounted on a tip of the arm of the robot;
a guide member provided in the vicinity the die of the nibbler located at a cutting position along a moving path of the nibbler; and
a controller that controls the robot to move the nibbler along the guide member, wherein
the guide member has a first guide surface for restricting movement of the nibbler from the cutting position to a first side of a direction perpendicular to a traveling direction of the nibbler and the top-bottom direction by contact with a side surface of the die of the nibbler located at the cutting position.

8. The cutting apparatus according to claim 7, wherein
the guide member further has a second guide surface for restricting downward movement of the nibbler from the cutting position by contact with a lower surface of the die of the nibbler located at the cutting position.

9. The cutting apparatus according to claim 7, wherein
the guide member further has a third guide surface arranged on a side opposite to the first guide surface with respect to the die, for restricting movement of the nibbler from the cutting position to a second side of the direction perpendicular to the traveling direction of the nibbler and the top-bottom direction by contact with a side surface of the die of the nibbler located at the cutting position.

10. The cutting apparatus according to claim 1, wherein
the guide member comes in contact with a lower surface of a removed part that is an unnecessary part of the steel sheet to support the removed part from below.

11. The cutting apparatus according to claim 10, wherein
a part of the guide member, which is come in contact with the removed part of the steel sheet is made of a buffer material.
